(19) United States
(12) Patent Application Publication
(10) Pub. No.: US 2010/0252578 A1
(43) Pub. Date: Oct. 7, 2010

(54) ELASTOMERIC DISPENSING CONTAINER

(76) Inventor: Paul Koh, New York, NY (US)

Correspondence Address: FITCH EVEN TABIN & FLANNERY, 120 SOUTH LASALLE STREET, SUITE 1600, CHICAGO, IL, 60603-3406, US

(21) Appl. No.: 12/816,991

(22) Filed: Jun. 16, 2010

Related U.S. Application Data
(63) Continuation of application No. 11/701,203, filed on Feb. 1, 2007.

(51) Int. Cl. B65D 37/00; B65D 47/08; B67D 7/84

(52) U.S. Cl. 222/209; 222/212; 222/556; 222/180

(57) ABSTRACT

An elastomeric dispensing container for a fluid includes an elastomeric receptacle defining a chamber therein and having an integrally formed gasket extending radially from an opening formed on a lower end and a receptacle neck providing communications between the chamber and the opening, a relatively rigid sleeve disposed concentrically about the receptacle neck having a sleeve neck with a lower face adjacent to the integral gasket, a cap having a lid covering the receptacle opening and the integral gasket with a dispensing orifice formed therein and a cap neck extending from the lid disposed concentrically about the sleeve neck, and engaging means formed on the sleeve neck and the cap neck providing removable attachment therebetween wherein the engaging means secures the integral gasket in a compressed and substantially fluid-tight state between the lid and the sleeve lower face.

### CROSS-REFERENCE To RELATED APPLICATIONS

This application is a continuation of prior application Ser. No. 11/701,203, filed Feb. 1, 2007, which is hereby incorporated by reference as if reproduced in its entirety herein.

### BACKGROUND

This application relates broadly to containers for storing and dispensing fluids, specifically to such containers of the type utilizing an elastomeric receptacle and a dispensing cap.

Elastomeric containers, particularly in the form of elastomeric receptacles with dispensing caps, are commonly used for storing and dispensing fluids. A typical example is an oil cup of the type described in U.S. Pat. No. 811,801. To dispense the fluid, the receptacle is compressed to pressurize and expel the fluid through an orifice in the cap. The flexible yet resilient elastomeric receptacle provides a relatively easy to use, comfortable, precise, and powerful means to dispense the fluid, while also providing a convenient means to store the fluid. Typically manufactured through a molding process, the elastomeric receptacles can be formed in a variety of shapes and colors, and can include integrally molded features which can improve functionality without requiring additional parts.

Engagement between the receptacle and the cap is conventionally accomplished though a cylindrical neck formed on the receptacle engaged around a relatively rigid cylindrical neck on the cap. This method of attachment relies on a tight radial fit between the receptacle neck and the cap neck in order to create a substantially fluid-tight seal. However, the tight fit also often makes the cap difficult to attach and detach, which must typically be done regularly for purposes of cleaning, refilling, or the like. The receptacle neck sometimes further includes integrally formed annular beads or screw threads as means for attachment. However, these features formed on the elastomeric receptacle are often not rigid enough to provide secure attachment, and may also be prone to leakage. In an embodiment described in U.S. Pat. No. 811,801, a threaded metal extension is introduced between a threaded cap and an elastomeric receptacle to facilitate attachment and detachment of the cap. However, engagement between the extension and the sleeve still relies on the conventional method heretofore described. While cement is proposed to connect the receptacle to the extension, the use of cement is undesirable as it complicates assembly.

Accordingly, in addition to the objects and advantages described above, it is an object and advantage of the present invention to provide an elastomeric dispensing container comprising an elastomeric receptacle and a dispensing cap in secure and substantially fluid-tight engagement which also facilitates attachment and detachment of the cap. Further objects and advantages are to provide an elastomeric dispensing container that is easy and comfortable to use, convenient, and facilitates cleaning and refilling. Still further objects and advantages of my invention will become apparent from a consideration of the drawings and ensuing description.

### SUMMARY

In accordance with the present invention an elastomeric dispensing container for a fluid comprises an elastomeric receptacle defining a chamber therein and having an integrally formed gasket extending radially from an opening formed on a lower end and a receptacle neck providing communications between the chamber and the opening, a relatively rigid sleeve disposed concentrically about the receptacle neck having a sleeve neck with a lower face adjacent to the integral gasket, a cap having a lid covering the receptacle opening and the integral gasket with a dispensing orifice formed therein and a cap neck extending from the lid disposed concentrically about the sleeve neck, and engaging means formed on the sleeve neck and the cap neck providing removable attachment therebetween wherein the engaging means secures the integral gasket in a compressed and substantially fluid-fight state between the lid and the sleeve lower face.

### BRIEF DESCRIPTION OF THE DRAWINGS

FIG. 1 is a front view of an elastomeric dispensing container;

FIG. 2A is a side cross-sectional view of the container of FIG. 1, taken along line 2-2 in FIG. 1;

FIG. 2B is a side cross-sectional view of an elastomeric receptacle, taken along line 2-2 in FIG. 1;

FIG. 2C is a side cross-sectional view of a relatively rigid sleeve, taken along line 2-2 in FIG. 1;

FIG. 2D is a side cross-sectional view of a dispensing cap, taken along line 2-2 in FIG. 1;

FIG. 3 is a perspective view of the container of FIG. 1;

FIG. 4 shows a perspective view of an elastomeric dispensing container with alternate indicia;

FIG. 5 shows a perspective view of an elastomeric dispensing container with alternate indicia; and

FIG. 6 shows a perspective view of an elastomeric dispensing container with an integrally formed hole.

### DETAILED DESCRIPTION

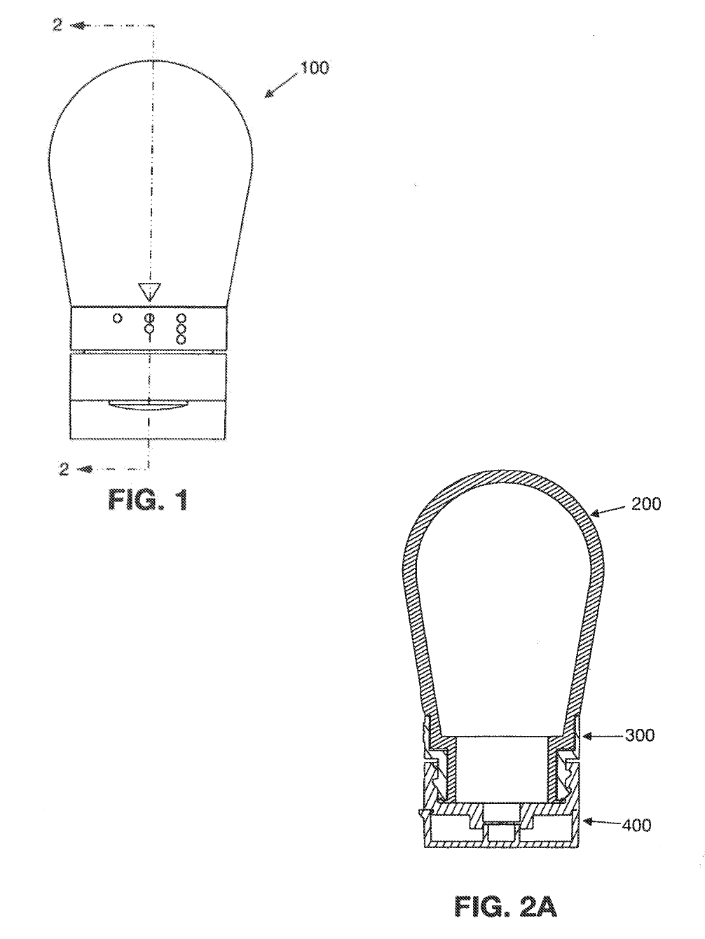

A preferred embodiment of an elastomeric dispensing container 100 and its components are shown in FIGS. 1-3. The container 100 includes a flexible and resilient elastomeric receptacle in the form of a squeeze bulb 200, a relatively rigid sleeve 300, and a dispensing cap 400.

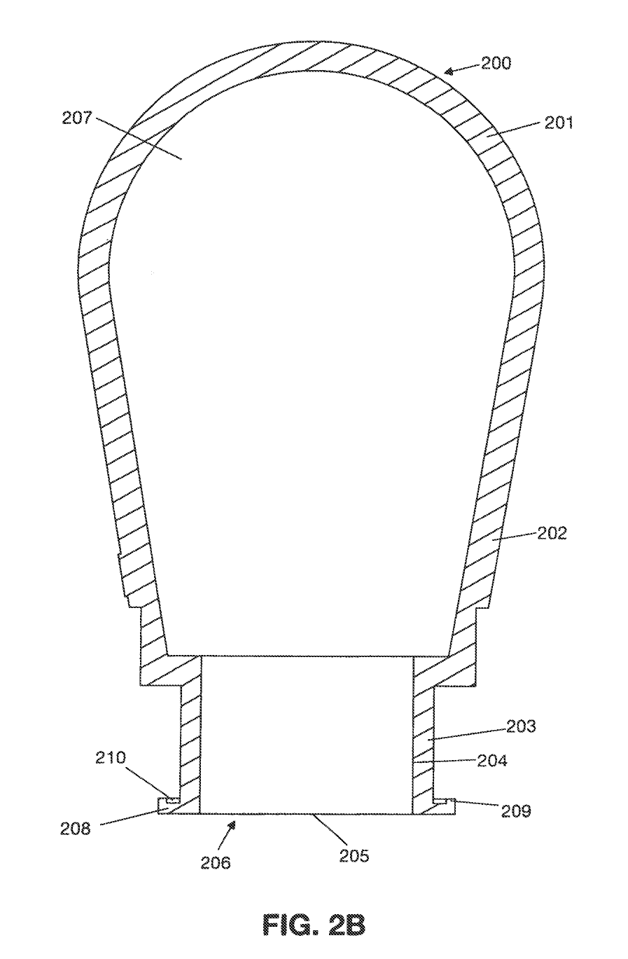

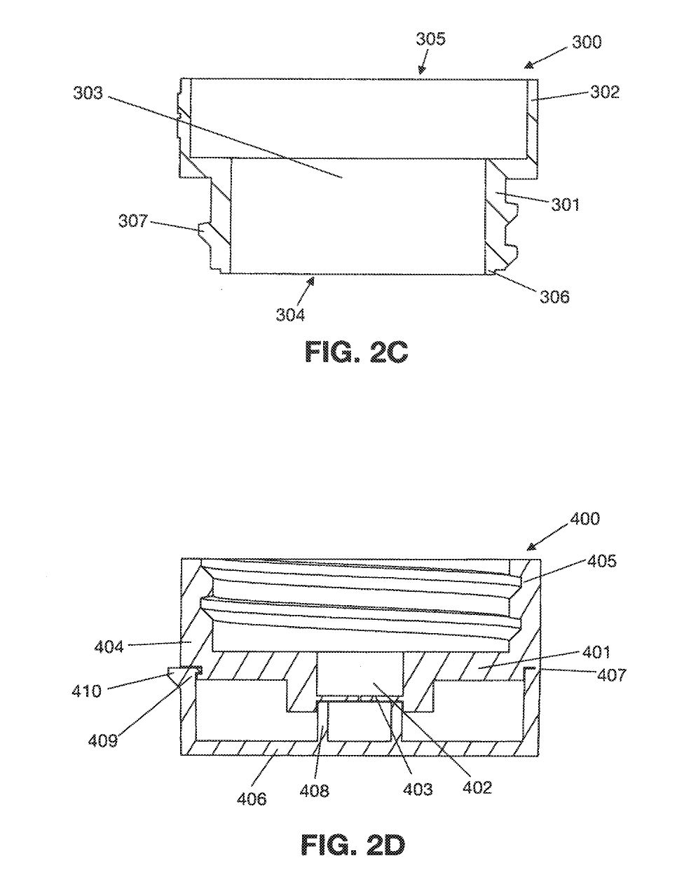

Referring to FIG. 2B, the squeeze bulb 200 has a main body 201 which is generally spherical in shape, passing into a tapered portion 202, passing into to a stepped cylindrical receptacle neck 203 with an inner diameter 204, and terminating in an opening 205 formed at a lower end 206. The inner diameter 204 is preferably of sufficient size to facilitate refilling and cleaning an inner chamber 207 defined within squeeze bulb 200. The receptacle neck 203 provides communication between the opening 205 and the chamber 207. An integral gasket 208 extends outwardly from the opening 205, and includes a circumferential rib 209 defining an annular retaining channel 210. The squeeze bulb 200 is formed of an elastomeric material, preferably silicone for its favorable mechanical properties and chemical inertness, although any other suitable elastomeric material could be used, such as the types sold under the trade names SANTOPRENE and KRATON. The elastomeric material is further preferably substantially light-transmitting to make visible a fluid contained in the squeeze bulb 200, and of an appropriate durometer, such as 40 Shore A, to make the squeeze bulb 200 substantially deformable yet resilient.

Referring to FIG. 2C, the sleeve 300 has a cylindrical sleeve neck 301 with a lower face 304, passing into a shoulder 302 with an upper face 305. An internal passage 303 is configured to receive and have a close, but rotationally free fit with the receptacle neck 203. The sleeve 300 further includes an annular retaining rib 306 formed on the lower face 304, where the retaining rib 306 is dimensioned to be received in the squeeze bulb retaining channel 210. An external thread 307 is formed on the sleeve neck 301, preferably of an industry-standard size, such as 33-400, so that a variety of readily available stock caps could be used. The sleeve 300 is formed of a relatively rigid material, such as polycarbonate, although any other suitable material could be used.

Referring to FIG. 2D, the dispensing cap 400 has a lid 401 which is dimensioned to cover the squeeze bulb opening 205 and the integral gasket 208. A dispensing orifice 402 is formed in the lid 401. A cross-cut silicone valve 403 is included within the orifice 402. A cap neck 404 extends upward from the lid 401, and includes an internal thread 405, where the cap neck 404 and the internal thread 405 are dimensioned to receive and engage the sleeve neck 301 and the sleeve external thread 307. The cap 400 further includes a cover 406 hingedly attached by a bi-stable living hinge 407 which holds the cover 406 away from the orifice 402 during dispensing. The cover 406 is configured to provide a stable base on which the container 100 can stand on a flat surface. The cover 406 includes an integrally formed plunger 408 which is positioned and dimensioned to seal the orifice 402 when the cover 406 is in a closed position. The cap 400 further includes a detent 409 and a protruding lip 410 formed on the cover 406. The cap 400 is preferably formed of a relatively rigid material, such as PP (polypropylene) plastic, which provides a high cycle life for the living hinge 407. While a preferred cap 400 has been described here, it is to be understood that any of a broad range of well known and readily available dispensing caps could also be used.

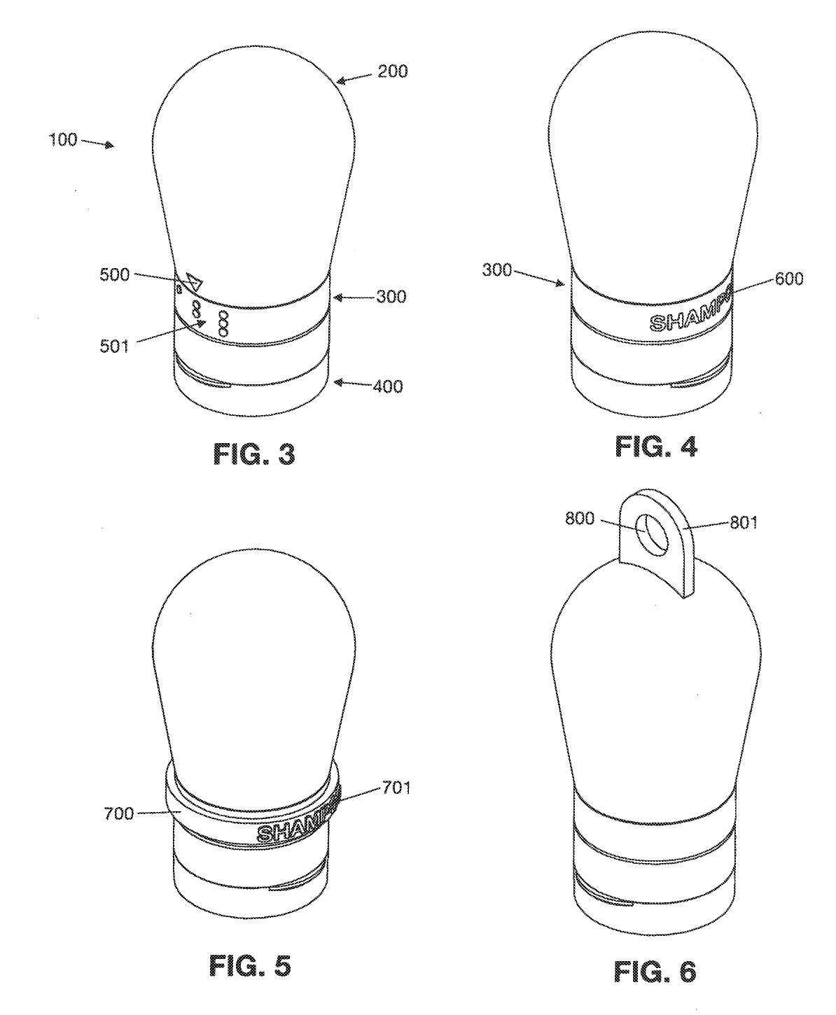

Referring to FIG. 3, an arrow 500 is formed on the squeeze bulb 200 adjacent to the sleeve shoulder 302 and a plurality of radially-spaced symbols 501 is formed on the sleeve shoulder 302.

Referring to FIGS. 2A-2D, in assembly, the sleeve 300 is first engaged to the squeeze bulb 200 by pushing the squeeze bulb lower end 206 through the sleeve internal passage 303. The integral gasket 208 and the receptacle neck 203 deflect inward to allow their passage though the sleeve neck 301. When fully engaged, the sleeve 300 is captured between the integral gasket 208 and the receptacle lower end 202, and the retaining rib 306 is fully seated in the annular channel 210. The cap 400 is attached by grasping the sleeve shoulder 302 to provide support, and then screwing on the cap 400 until the integral gasket 208 is compressed between the lid 401 and the sleeve lower face 304 and a secure and substantially fluid-tight engagement between the squeeze bulb 200 and the cap 400 has been created.

Referring to FIGS. 2A-2D, in operation, the squeeze bulb 200 filled through the opening 205 after unscrewing the cap 400. When the cap 400 is loosened, the bulb 200 and the sleeve 300 can be rotated relative to one another to align the arrow 500 to an appropriate selection from the symbols 501. When the cap 400 is fully engaged to the sleeve 200, friction provided by the compressed integral gasket 208 prevents relative rotational movement between the sleeve 300 and the squeeze bulb 200. After the cap 400 has been reattached, the container 100 can stand on the cover 406, such that gravity maintains the fluid near the orifice 402 so the fluid is more readily dispensed. To dispense the fluid, the cover 406 is opened by pushing on the lip 410 to overcome the detent 409, and the squeeze bulb 200 is compressed until a sufficient internal fluid pressure has been created to open the valve 403. When the pressure is released, the valve 403 closes immediately, preventing the fluid from dripping. To clean the interior of the container 100, the cap is detached by grasping the sleeve shoulder 302 for support and unscrewing the cap 400. A cleaning instrument; such as a user's finger, can then enter into the squeeze bulb 200 through opening 205.

FIG. 4 and FIG. 5 show alternate indicia for the contents of the container 100. In FIG. 4, a phrase 600 is formed on the sleeve shoulder 302. The phrase 600 can either be integrally molded on sleeve 300, or printed subsequent to molding. In FIG. 5, an elastomeric band 700 with an integrally formed phrase 701 is removably engaged to the sleeve shoulder 302, so that it can be easily replaced by an alternate band, depending on the contents. The band 700 also enhances a user's grip on the shoulder 302, aiding in attaching and detaching the cap 400.

Referring to FIG. 6, an alternate embodiment of the squeeze bulb 200 is shown where a hole 800 is formed on a flange 801 integrally formed on the squeeze bulb 200 to allow for convenient hanging of the container 100.

Thus it will be seen that the elastomeric dispensing container of the invention provides a secure, substantially fluid-tight engagement of the elastomeric receptacle 200 to the cap 400 while still facilitating attachment and detachment of the cap 400, and is also easy and comfortable to use, convenient, and facilitates cleaning and refilling.

Although illustrative embodiments of the present invention have been described herein with reference to the accompanying drawings, it is to be understood that the invention is not limited to those precise embodiments and methods and that various other changes may be effected herein by one skilled in the art without departing from the scope or spirit of the invention. For example, while specific materials, shapes, and indicia have been disclosed for the various parts of container 100, other materials, shapes, and indicia could be used. While a specific dispensing cap has been described, a variety of dispensing closures and nozzles could be used. Also, while an application involving a dispensing container has been described herein, the present invention may be applicable in other situations requiring fluid-tight attachment of a squeeze bulb, such as basting devices, or medical devices for extracting and discharging fluids.

Accordingly, the scope of the invention should be determined not by the embodiments illustrated, but by the appended claims and their legal equivalents.

1. An elastomeric dispensing container for a fluid comprising:
a flexible and resilient receptacle composed of an elastomeric material defining a chamber therein and having an integrally formed gasket extending radially from an opening formed on a lower end and a receptacle neck providing communications between the chamber and the opening,
a relatively rigid sleeve disposed concentrically about the receptacle neck having a sleeve neck with a lower face adjacent to the integral gasket,
a cap having a lid covering the receptacle opening and the integral gasket with a dispensing orifice formed therein and a cap neck extending from the lid disposed concentrically about the sleeve neck, and
engaging means formed on the sleeve neck and the cap neck providing removable attachment therebetween wherein the engaging means secures the integral gasket in a compressed and substantially fluid-tight state between the lid and the sleeve lower face.

2. The container of claim 1, wherein the receptacle is configured as a flexible and resilient squeeze bulb.

3. The container of claim 1, wherein the elastomeric material is silicone.

4. The container of claim 1, wherein the elastomeric material is substantially light-transmitting.

5. The container of claim 1, further including sealing means for the orifice.

6. The container of claim 5, wherein the sealing means comprises a cover hingedly attached to the cap with an integrally formed plunger adapted to seal the orifice.

7. The container of claim 1, wherein the cap further includes standing means whereby the cap provides a stable base on which the container can stand on a flat surface such that a fluid contained in the receptacle is urged by gravity towards the dispensing orifice and is more readily dispensed.

8. The container of claim 7, wherein the standing means comprises a substantially flat surface formed on the cap normal to a longitudinal axis of the container.

9. The container of claim 1, further including indicia for a fluid contained in the receptacle.

10. The container of claim 9, wherein the indicia are formed on the receptacle and the sleeve, whereby rotation of the receptacle relative to the sleeve aligns the receptacle indicia to the sleeve indicia.

11. The container of claim 9, wherein the indicia are formed on an elastomeric band removably engaged to the container.

12. The container of claim 1, wherein the cap further includes valving means to regulate flow from the dispensing orifice.

13. The container of claim 12, wherein the valving means comprises a cross-cut elastomeric valve.

14. The container of claim 1, wherein the engaging means comprises screw threads.

15. The container of claim 1, wherein the sleeve further includes a shoulder which may be grasped to provide support while engaging the cap.

16. The container of claim 1, wherein the receptacle further includes an integrally formed hole whereby the container can be conveniently hung.

17. The container of claim 1, further including additional securing means for the integral gasket to the sleeve.

18. The container of claim 17, wherein the additional securing means comprises an annular rib formed on the sleeve lower face and an annular channel formed on the integral gasket facing the sleeve lower face adapted to receive the annular rib.
